(19) United States
(12) Patent Application Publication
(10) Pub. No.: US 2022/0012649 A1
(43) Pub. Date: Jan. 13, 2022

(54) CONTROL METHOD, CONTROL SYSTEM, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Junichiro SOEDA, Nara (JP); Yuuki HIROSE, Osaka (JP); Tetsuji FUCHIKAMI, Osaka (JP); Motoji OHMORI, Osaka (JP)

(21) Appl. No.: 17/482,986

(22) Filed: Sep. 23, 2021

Related U.S. Application Data
(63) Continuation of application No. PCT/JP2020/016444, filed on Apr. 14, 2020.
(60) Provisional application No. 62/834,732, filed on Apr. 16, 2019.

(51) Int. Cl. G06Q 10/02; G06Q 30/02

(52) U.S. Cl. CPC G06Q 10/02; G06Q 30/0226

(57) ABSTRACT

A control method includes obtaining, from a first terminal of a first user, reservation information including a use start date and time of an electric-powered vehicle that the first user hopes to use at a future time and that is being used by a second user; obtaining an amount of remaining battery of the electric-powered vehicle; calculating charge start date and time based on the amount of remaining battery obtained, the charge start date and time being a date and time at which the electric-powered vehicle should start being charged so that an amount of remaining battery of the electric-powered vehicle becomes no less than a predetermined value at the use start date and time included in the reservation information obtained; and transmitting notification information including the charge start date and time calculated to the electric-powered vehicle.

### CROSS REFERENCE TO RELATED APPLICATIONS

This is a continuation application of PCT International Application No. PCT/JP2020/016444 filed on Apr. 14, 2020, designating the United States of America, which is based on and claims priority of U.S. Provisional Patent Application No. 62/834,732 filed on Apr. 16, 2019. The entire disclosures of the above-identified applications, including the specifications, drawings and claims are incorporated herein by reference in their entirety.

### FIELD

The present disclosure relates to a control method, a control system, and a recording medium.

### BACKGROUND

For use in a charging management system for an electric-powered vehicle, such as an electric automobile, there exists a technique for improving the operation efficiency of a charger by use of boost charging (see PTL 1).

### CITATION LIST

### Patent Literature

PTL 1: Japanese Unexamined Patent Application Publication No. 2014-39409

### SUMMARY

### Technical Problem

However, there is still room for improvement in the operation efficiency of an electric-powered vehicle.

Accordingly, the present disclosure provides a control method and so on that improve the operation efficiency of an electric-powered vehicle.

### Solution to Problem

A control method according to one aspect of the present disclosure includes: obtaining, from a first terminal of a first user, reservation information including a use start date and time of an electric-powered vehicle that the first user hopes to use at a future time and that is being used by a second user; obtaining an amount of remaining battery of the electric-powered vehicle; calculating a charge start date and time based on the amount of remaining battery obtained, the charge start date and time being a date and time at which the electric-powered vehicle should start being charged so that an amount of remaining battery of the electric-powered vehicle becomes no less than a predetermined value at the use start date and time included in the reservation information obtained; and transmitting notification information including the charge start date and time calculated to the electric-powered vehicle.

It is to be noted that general or specific aspects of the above may be implemented in the form of a system, an apparatus, an integrated circuit, a computer program, or a computer-readable recording medium, such as a CD-ROM, or through any desired combination of a system, an apparatus, an integrated circuit, a computer program, and a recording medium.

### Advantageous Effects

The control method according to the present disclosure improves the operation efficiency of an electric-powered vehicle.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram schematically illustrating a configuration of a control system according to Embodiment 1.

FIG. 2 is a block diagram schematically illustrating a configuration of a server according to Embodiment 1.

FIG. 3 is a table illustrating an example of reservation information according to Embodiment 1.

FIG. 4 is a graph illustrating an example of a charging characteristic of a battery according to Embodiment 1.

FIG. 5 is a table illustrating an example of notification information according to Embodiment 1.

FIG. 6 is a flowchart illustrating a control method to be executed by the server according to Embodiment 1.

FIG. 7 is a sequence diagram illustrating a process of the control system as a whole according to Embodiment 1.

FIG. 8 is a block diagram schematically illustrating a configuration of a control system according to Embodiment 2.

FIG. 9 is a block diagram schematically illustrating a configuration of a server according to Embodiment 2.

FIG. 10 is a first flowchart illustrating a control method to be executed by the server according to Embodiment 2.

FIG. 11 is a second flowchart illustrating a control method to be executed by the server according to Embodiment 2.

FIG. 12 is a sequence diagram illustrating a process of the control system as a whole according to Embodiment 2.

FIG. 13 is a diagram illustrating a data structure of a blockchain.

FIG. 14 is a diagram illustrating a data structure of transaction data.

### DESCRIPTION OF EMBODIMENTS

### (Underlying Knowledge Forming Basis of the Present Disclosure)

The present inventor has found the following problem with respect to the technique related to an electric-powered vehicle described in the Background section.

Electric-powered vehicles are widely used. An electric-powered bicycle is an example of such electric-powered vehicles. In the following section, some usage modes of electric-powered vehicles will be described with electric-powered bicycles serving as an example.

In one service mode related to electric-powered bicycles, electric-powered bicycles are managed by a service provider company and rented out to users each time the users use the electric-powered bicycles. In this mode, the electric-powered bicycles are charged at a charging station while they are not rented out. To use an electric-powered bicycle, a user, for example, walks to the charging station and starts using an electric-powered bicycle upon renting it at the charging station. When the user is to end the use of the electric-powered bicycle, the user travels to the charging station by the electric-powered bicycle and returns the electric-powered bicycle at the charging station. The electric-powered bicycle that is no longer being used by the user is recharged at the charging station.

When a service provider company takes a reservation for an electric-powered bicycle from a user who wants to use it at a future time, the electric-powered bicycle needs to be present at a charging station and have a sufficient amount of remaining battery at the time when the user starts using the electric-powered bicycle.

If the amount of remaining battery is not sufficient, the battery of the electric-powered bicycle may be depleted while the user is using the electric-powered bicycle, and the electric-powered bicycle may thus become inoperable. If, in order to prevent an electric-powered bicycle from becoming inoperable, a plenty of time is spent on charging the electric-powered bicycle at a charging station, this may create an unnecessarily extended period in which users cannot use the electric-powered bicycle, which may result in a decrease in the operation efficiency of the electric-powered bicycle. Such a decrease in the operation efficiency of an electric-powered bicycle in turn results in a decrease in the use efficiency of resources and a decrease in the power consumption efficiency.

In this manner, there is room for improvement in the operation efficiency of an electric-powered vehicle, such as an electric-powered bicycle.

Accordingly, the present disclosure provides a control method and so on that improve the operation efficiency of an electric-powered vehicle.

According to an exemplary embodiment disclosed herein, a control method includes obtaining, from a first terminal of a first user, reservation information including a use start date and time of an electric-powered vehicle that the first user hopes to use at a future time and that is being used by a second user; obtaining an amount of remaining battery of the electric-powered vehicle; calculating a charge start date and time based on the amount of remaining battery obtained, where the charge start date and time is a date and time at which the electric-powered vehicle should start being charged so that an amount of remaining battery of the electric-powered vehicle becomes no less than a predetermined value at the use start date and time included in the reservation information obtained; and transmitting notification information including the charge start date and time calculated to the electric-powered vehicle.

According to the above aspect, the second user is informed, via the electric-powered vehicle, of the charge start date and time at which the electric-powered vehicle should start being charged so that the electric-powered vehicle to be used by the first user at a future time will have a sufficient amount of remaining battery at the time when the electric-powered vehicle is to be used by the first user. The second user can find the charge start date and time at which the electric-powered vehicle should start being charged so that the electric-powered vehicle being used by the second user will have a sufficient amount of remaining battery when that electric-powered vehicle is to be used by the first user at a future time. If the second user who has come to know the charge start date and time ends the use of the electric-powered vehicle by the informed charge start date and time, the electric-powered vehicle can be charged after the second user has ended the use of the electric-powered vehicle and can then be used by the first user. If such a management is not performed, the electric-powered vehicle may have an insufficient amount of battery remaining when the first user hopes to start using the electric-powered vehicle, and the battery may be depleted while the first user is using the electric-powered vehicle, possibly making the electric-powered vehicle inoperable. As the second user is informed of the charge start date and time as described above, the electric-powered vehicle having a sufficient amount of remaining battery can be operated and shared efficiently among a plurality of users. Therefore, the control method according to one aspect of the present disclosure can improve the operation efficiency of an electric-powered vehicle.

The notification information may further include information regarding a first incentive that is to be provided to the second user when the second user moves the electric-powered vehicle to a charging station to end the use of the electric-powered vehicle by the charge start date and time calculated.

According to the above aspect, the second user is informed that the second user can be provided with an incentive if the second user ends the use of the electric-powered vehicle by the notified charge start date and time. Since the second user can be provided with an incentive if the second user ends the use of the electric-powered vehicle by the notified charge start date and time, this can motivate the second user to end the use of the electric-powered vehicle by the notified charge start date and time. As a result, this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

The control method may further include executing a providing process of providing the second user with the first incentive included in the notification information, in response to obtaining information indicating that the second user has ended the use of the electric-powered vehicle.

According to the above aspect, the second user who has ended the use of the electric-powered vehicle by the notified charge start date and time can be provided with an incentive. In this manner, since the processes such as the transmission of the notification information as well as the process of providing the incentive can be executed as a series of processes, the efficiency of information processing improves, and the power consumption can be reduced advantageously. Therefore, the control method according to one aspect of the present disclosure can improve the operation efficiency of an electric-powered vehicle while improving the efficiency of information processing.

The providing process may further include a process of providing the second user with a second incentive, and the earlier the second user ends the use of the electric-powered vehicle, the greater the amount of the second incentive may be.

According to the above aspect, if the second user is to end the use of the electric-powered vehicle by the charge start date and time in accordance with the notification information, the incentive that the second user is to be provided with is greater as the second user ends the use of the electric-powered vehicle earlier. Therefore, this can motivate the second user to end the use of the electric-powered vehicle earlier. As a result, this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

The reservation information may include information for identifying a starting station, and the starting station may be a charging station in a use start location of the electric-powered vehicle that the first user hopes to use.

The providing process may further include a process of providing the second user with a second incentive. The closer an ending station is to the starting station, the greater the amount of the second incentive may be, and the ending station may be a charging station where the second user ends the use of the electric-powered vehicle.

According to the above aspect, if the second user is to end the use of the electric-powered vehicle by the charge start date and time in accordance with the notification information, the incentive that the second user is to be provided with is greater as the second user ends the use of the electric-power vehicle at a charging station closer to the charging station where the first user who is to use the electric-powered vehicle next is to start using the electric-powered vehicle. Therefore, this can motivate the second user to end the use of the electric-powered vehicle at a charging station closer to the charging station where the first user is to start using the electric-powered vehicle. As a result, this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

When there are a plurality of candidate vehicles, the notification information may be transmitted to each of the plurality of candidate vehicles, and the plurality of candidate vehicles may each be a candidate to be used as the electric-powered vehicle that the first user is to use at a future time. One or more items of acceptance information may be received, and the acceptance information indicating that the second user of the candidate vehicle that received the notification information has accepted to end the use of the electric-powered vehicle. The providing process of providing the first incentive is executed only for the second user who transmitted the acceptance information received at an earliest time among the one or more items of acceptance information received.

According to the above aspect, if the second user is to end the use of the electric-powered vehicle by the charge start date and time in accordance with the notification information, the incentive that the second user is to be provided with is greater as the second user transmits the acceptance information earlier. Therefore, this can motivate the second user to transmit the acceptance information earlier. As a result, more pieces of acceptance information are transmitted, and this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

The control method may further include generating transaction data including information regarding the first incentive and storing the transaction data generated into a plurality of distributed ledgers.

According to the above aspect, since it is practically impossible to alter the transaction data stored in the distributed ledgers, the information regarding the incentives can be managed appropriately. Therefore, the control method according to one aspect of the present disclosure can improve the operation efficiency of an electric-powered vehicle while managing the information appropriately.

When the charge start date and time is calculated, the charge start date and time may be calculated by calculating a time it takes for an amount of remaining battery of the electric-powered vehicle to reach the predetermined value from the amount of remaining battery obtained, by use of a predetermined charging characteristic unique to a battery of the electric-powered vehicle.

According to the above aspect, the charge start date and time can be calculated more simply and more accurately by use of the charging characteristic of the battery. Therefore, the control method according to one aspect of the present disclosure can improve the operation efficiency of an electric-powered vehicle by use of the charge start date and time that is based on a simpler and more accurate calculation.

The reservation information may include path information indicating a path along which the first user travels by the electric-powered vehicle, and the predetermined value may be calculated as a value obtained by adding an amount of electric power required for the electric-powered vehicle to travel along the path indicated by the path information to a lower limit value of an amount of remaining battery of the electric-powered vehicle.

According to the above aspect, since it suffices that the electric-powered vehicle be charged until the electric-powered vehicle has an amount of remaining battery necessary for the first user to use the electric-powered vehicle, the time it takes to charge the electric-powered vehicle can be reduced as compared to a case where the electric-powered vehicle is charged to have a more than necessary amount of remaining battery. Therefore, the time from when the second user ends the use of the electric-powered vehicle to when the first user starts using the electric-powered vehicle can be reduced, and in turn the operation efficiency of the electric-powered vehicle can be further improved. In this manner, the control method according to one aspect of the present disclosure can improve the operation efficiency of an electric-powered vehicle.

According to an exemplary embodiment disclosed herein, a control system includes a server and a charging station. The charging station includes charging equipment for charging an electric-powered vehicle. The server includes an obtainer, a calculator, and a notifier. The obtainer (a) obtains, from a first terminal of a first user, reservation information including a use start date and time of an electric-powered vehicle that the first user hopes to use at a future time and that is being used by a second user and (b) obtains an amount of remaining battery of the electric-powered vehicle. The calculator calculates a charge start date and time based on the amount of remaining battery obtained, and the charge start date and time is a date and time at which the electric-powered vehicle should start being charged so that an amount of remaining battery of the electric-powered vehicle becomes no less than a predetermined value at the use start date and time included in the reservation information obtained. The notifier transmits notification information including the charge start date and time calculated to the electric-powered vehicle.

The above aspect provides advantageous effects similar to those of the control method described above.

According to an exemplary embodiment disclosed herein, a recording medium is a non-transitory computer-readable recording medium for use in a computer, and the recording medium has a computer program recorded thereon for causing the computer to execute the control method described above.

The above aspect provides advantageous effects similar to those of the control method described above.

It is to be noted that these general or specific aspects may be implemented in the form of a system, an apparatus, an integrated circuit, a computer program, or a computer-readable recording medium, such as a CD-ROM, or through any desired combination of a system, an apparatus, an integrated circuit, a computer program, and a recording medium.

Hereinafter, some exemplary embodiments will be described in concrete terms with reference to the drawings.

It is to be noted that the exemplary embodiments described below merely illustrate general or specific examples. The numerical values, the shapes, the materials, the constituent elements, the arrangement positions and the connection modes of the constituent elements, the steps, the orders of the steps, and so on illustrated in the following exemplary embodiments are examples and are not intended to limit the present disclosure. Among the constituent elements in the following exemplary embodiments, any constituent element that is not included in the independent claims expressing the broadest concept is to be construed as an optional constituent element.

### Embodiment 1

According to the present embodiment, a control method and so on that improve the operation efficiency of an electric-powered vehicle will be described.

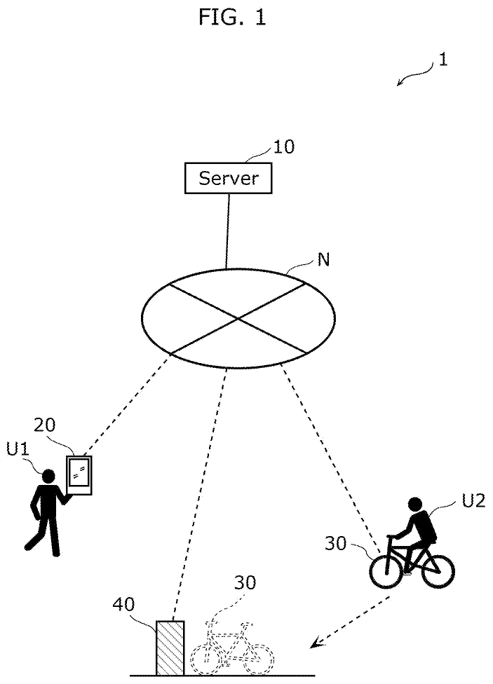

FIG. 1 is a block diagram schematically illustrating a configuration of control system 1 according to the present embodiment.

As illustrated in FIG. 1, control system 1 includes server 10 and station 40. Control system 1 is a system that controls the use of bicycle 30 by users U1, U2, and so on.

User U1 owns terminal 20. Terminal 20 is a communication terminal including a communication interface, and examples of terminal 20 include a mobile phone or a smartphone. Terminal 20 is connected to and is capable of communicating with server 10 via network N. User U1 performs an operation such as reserving bicycle 30 by use of terminal 20. User U1 is an example of a user who is not using bicycle 30 at the present time and is hoping to use bicycle 30 at a future time.

User U2 is an example of a user who is using bicycle 30.

Bicycle 30 is a bicycle whose use is controlled by control system 1. Bicycle 30 is an electric-powered bicycle, which is an example of an electric-powered vehicle. Bicycle 30 includes a rechargeable battery (a secondary battery). Bicycle 30 is ridden by any one of a plurality of users including users U1 and U2 and travels as electric power supplied from the battery actuates its wheels. The battery of bicycle 30 can be charged at station 40. In this example, the charging of the battery of bicycle 30 may simply be phrased as the charging of bicycle 30.

Bicycle 30 includes a communication interface. Bicycle 30 is connected to and is capable of communicating with server 10 via network N. Bicycle 30 further includes a processor and a memory. Bicycle 30 performs information processing as the processor executes a predetermined program by use of the memory. Bicycle 30 may obtain its position information by use of the Global Positioning System (GPS) or the like.

Bicycle 30 includes a presenter for presenting information to the user riding bicycle 30. The presenter is, for example but not limited to, a display screen that presents information by displaying an image thereon or a loudspeaker that presents information by outputting sounds.

In this example, the communication interface included in bicycle 30 may be a long-distance wireless communication interface that can connect to a mobile phone carrier network. Alternatively, the communication interface included in bicycle 30 may be a short-distance wireless communication interface, such as a Wi-Fi (registered trademark) interface or a Bluetooth (registered trademark) interface. In a case where the communication terminal included in bicycle 30 is a short-distance wireless communication interface, bicycle 30 can connect to network N via a communication terminal that is owned by user U2 using bicycle 30 and that includes a long-distance wireless communication interface, for example. In this example, instead of bicycle 30, other types of electric-powered vehicles such as an electric-powered automobile, an electric-powered scooter, or an electric-powered kickboard can also be used. Station 40 is a charging station for charging bicycle 30.

Station 40 is provided with charging equipment for charging bicycle 30. Station 40 connects the charging equipment to bicycle 30 and charges bicycle 30 by supplying electric power to the battery of bicycle 30. One or more bicycles 30 may be placed at station 40, and station 40 can charge one or more bicycles 30. Station 40 is connected to and is capable of communicating with server 10 via network N. Station 40 manages the amount of remaining battery of each of one or more bicycles 30 placed at station 40 and transmits the amount of remaining battery that station 40 manages to server 10.

Server 10 is a control device that controls the use of bicycle 30 by user U1 and so on. Specifically, server 10 manages the user or users of bicycle 30 by time. Upon receiving a reservation from user U1 for the use of bicycle 30, server 10 controls bicycle 30 so that user U1 can use bicycle 30 in accordance with the reservation.

Specifically, if there is bicycle 30 at station 40 when user U1 wants to use bicycle 30, server 10 controls bicycle 30 so that user U1 can use this bicycle 30 present at station 40.

If there is no bicycle 30 at station 40 when user U1 wants to use bicycle 30, server 10 may execute a process of notifying user U2 who is using bicycle 30 at the time when user U1 has made the reservation to terminate the use of bicycle 30 by user U2. The processes of server 10 will be described later in details.

In the following description, the assumed situation is that user U1 is hoping to use bicycle 30 at a future time, but no bicycle 30 is available at station 40 at the time when user U1 makes a reservation for bicycle 30, and user U2 is using bicycle 30 at that time.

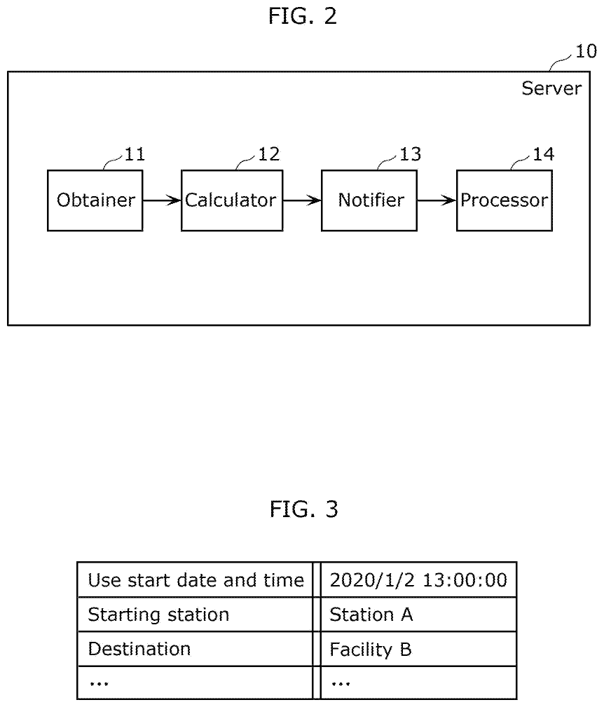

FIG. 2 is a block diagram schematically illustrating a configuration of server 10 according to the present embodiment.

As illustrated in FIG. 2, server 10 includes obtainer 11, calculator 12, notifier 13, and processor 14. Each functional unit included in server 10 may be implemented as a central processing unit (CPU) (not illustrated) included in server 10 executes a predetermined program by use of a memory.

Obtainer 11 is a functional unit that obtains various pieces of information related to a reservation for bicycle 30. Specifically, obtainer 11 obtains reservation information and an amount of remaining battery.

The reservation information obtained by obtainer 11 includes at least a use start date and time at which user U1 is to start using bicycle 30 that user U1 hopes to use at a future time and that is currently being used by user U2. The reservation information is transmitted by terminal 20.

The amount of remaining battery obtained by obtainer 11 is the amount of battery remaining at the present time of bicycle 30 that is being used. This amount of remaining battery is transmitted from bicycle 30 that is being used. In a case where there are one or more bicycles 30, obtainer 11 obtains the amount of remaining battery from each of one or more bicycles 30. The amount of remaining battery described above is information obtained by measuring the amount of battery remaining in the battery of bicycle 30. As “the amount of battery remaining at the present time”, the amount of remaining battery obtained by measuring the amount of battery remaining within a predetermined time (e.g., ten minutes) spanning from the present time to a predetermined time in the past can be used.

Calculator 12 is a functional unit that calculates a charge start date and time. The charge start date and time is the date and time at which the charging of bicycle 30 should start at station 40 so that the amount of remaining battery of bicycle 30 reaches or exceeds a predetermined value at the time indicated by the use start date and time included in the reservation information obtained by obtainer 11. When calculating the charge start date and time, calculator 12 uses the amount of remaining battery obtained by obtainer 11. In a case where there are a plurality of bicycles 30, calculator 12 calculates the charge start date and time for each of the plurality of bicycles 30.

To be more specific, calculator 12 calculates the charge start date and time by calculating, based on a predetermined charging characteristic unique to the battery of bicycle 30, the time it takes for the amount of remaining battery of bicycle 30 to reach a predetermined value from the amount of remaining battery obtained by obtainer 11.

Notifier 13 is a functional unit that transmits notification information including the charge start date and time calculated by calculator 12 to bicycle 30. The notification information transmitted to bicycle 30 may be presented to user U2 by the presenter included in bicycle 30. In this example, notifier 13 may transmit the notification information including the charge start date and time calculated by calculator 12 to a terminal (not illustrated) owned by user U2.

The notification information to be transmitted by notifier 13 may include information regarding any incentive to be provided to user U2. For example, the information regarding such an incentive may include information indicating an incentive (also referred to as a first incentive) to be provided to user U2 if user U2 moves bicycle 30 to station 40 to end the use of bicycle 30, that is, if user U2 returns bicycle 30 to station 40 by the charge start date and time calculated by calculator 12.

In this example, when notifier 13 is to transmit the notification information, if the present time is determined to be past the charge start date and time, the notification information may be prohibited from being transmitted. Notifier 13 can make a determination on the charge start date and time by use of the position information of bicycle 30. These will be elaborated later.

Processor 14 is a functional unit that executes a providing process of providing an incentive to user U2. Specifically, with regard to the providing process, processor 14 executes a providing process of providing user U2 with a first incentive indicated in the notification information, in response to obtaining information indicating that user U2 has ended the use of bicycle 30 in response to the notification information transmitted by notifier 13.

The providing process may further include a process of providing user U2 with another incentive (also referred to as a second incentive) different from the first incentive. The amount of the second incentive is set to a greater value as user U2 ends the use of bicycle 30 at an earlier time, for example.

In this example, the reservation information to be obtained by obtainer 11 may include information that identifies a starting station. A starting station is a charging station located at a use start location where user U1 hopes to start using bicycle 30. In this case, the amount of the second incentive is set to a greater value as an ending station is closer to the starting station. An ending station is a charging station where user U2 ends the use of bicycle 30.

In this example, when notifier 13 transmits the notification information, if there are a plurality of candidate vehicles that are each a candidate to be used as bicycle 30 that user U1 uses at a future time, notifier 13 may transmit the notification information to each of the plurality of candidate vehicles. In this case, processor 14 receives one or more items of acceptance information each indicating that user U2 of the candidate vehicle to which the notification information has been transmitted has accepted to end the use of bicycle 30. Then, processor 14 executes the providing process of providing the first incentive only to user U2 who has transmitted the acceptance information received at an earliest time among the one or more items of acceptance information received by processor 14.

In this example, the reservation information to be obtained by obtainer 11 may include path information indicating a path along which user U1 travels by bicycle 30. In this case, the predetermined value that calculator 12 uses to calculate the charge start date and time is calculated as a value obtained by adding the amount of electric power required for bicycle 30 to travel along the path indicated by the path information to a lower limit value of the amount of remaining battery of bicycle 30. The path information includes, for example, information indicating a destination or information indicating a destination and a location en route to the destination. In a case where the path information includes information indicating a destination, the path indicated by the path information is the path along which user U1 travels by bicycle 30 from a starting station to the destination and then travels back from the destination to the starting station. In a case where the path information includes information indicating a destination and a location en route to the destination, the path indicated by the path information is the path along which user U1 travels by bicycle 30 between a starting station and the destination via the location indicated by the path information either on the way from the starting station to the destination or on the way from the destination to the starting station. In this example, there may be a plurality of such locations on the route.

FIG. 3 is a table illustrating an example of the reservation information according to the present embodiment.

As illustrated in FIG. 3, the reservation information includes the use start date and time, the starting station, and the destination. In this example, the starting station and the destination are optional.

The use start date and time is the date and time at which user U1 hopes to start using bicycle 30. User U1 intends to start using bicycle 30 at the point in time indicated by the use start date and time.

The starting station provides information indicating a charging station where user U1 hopes to start using bicycle 30. The starting station can be indicated in any format as long as that information allows the charging station to be identified on a map. For example, information indicating the name or the position (e.g., the latitude, the longitude, the floor number, or the like) of a facility can be used.

The destination provides information indicating the destination to which user U1 is to travel by bicycle 30. The destination can be indicated in any format as long as that information allows the destination to be identified on a map. For example, information indicating the name or the position (e.g., the latitude, the longitude, the floor number, or the like) of a facility can be used. The destination is an example of the path information indicating the path along which user U1 travels by bicycle 30.

The reservation information illustrated in FIG. 3 is an example of the reservation information based on which user U1 is to start using bicycle 30 at the use start date and time of “Jan. 2, 2020, at 13:00”, which is future date and time. This reservation information also indicates that user U1 is to start using bicycle 30 at station A and make a round trip between station A and facility B.

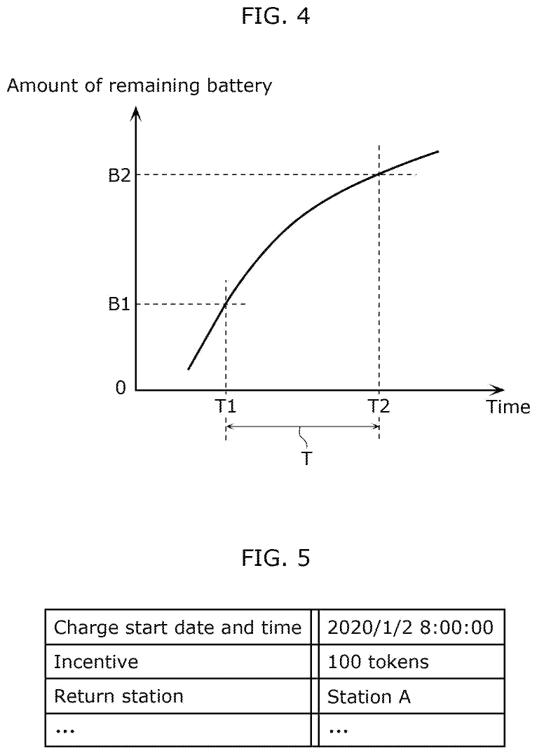

FIG. 4 is a graph illustrating an example of a charging characteristic of a battery according to the present embodiment. The charging characteristic illustrated in FIG. 4 is an example of a predetermined charging characteristic unique to the battery of bicycle 30.

The charging characteristic illustrated in FIG. 4 indicates a change in the amount of remaining battery (the vertical axis) with respect to the charging time (the horizontal axis) of the battery observed when the battery is being charged.

If the battery having the charging characteristic illustrated in FIG. 4 has the amount of remaining battery of B1 at time T1, for example, the battery will have the amount of remaining battery of B2 at time T2 upon being charged. The time it takes for the amount of remaining battery to change from B1 to B2 is T.

When calculator 12 calculates the charge start date and time by using the charging characteristic of the battery, calculator 12 calculates charge start date and time T1 by using the amount of remaining battery at the present time obtained by obtainer 11 as B1 in FIG. 4, the predetermined value as B2 in FIG. 4, and the use start date and time as T2.

FIG. 5 is a table illustrating an example of the notification information according to the present embodiment.

As illustrated in FIG. 5, the notification information includes the charge start date and time, the incentive, and a return station. In this example, the incentive and the destination are optional.

The charge start date and time is the date and time at which the battery should start being charged so that the amount of remaining battery of bicycle 30 reaches or exceeds the predetermined value at the point in time indicated by the use start date and time of user U1. The charge start date and time is information calculated by calculator 12.

The incentive provides information indicating the incentive (the first incentive) to be provided to user U2 if user U2 moves bicycle 30 to station 40 to end the use of bicycle 30 by the charge start date and time.

The return station provides information indicating station 40 to which user U2 is recommended to return bicycle 30. The return station may be set by notifier 13 to the charging station that is the same as station 40 where user U1 is to start using bicycle 30. The process of server 10 and the process of control system 1 as a whole configured as described above will now be described.

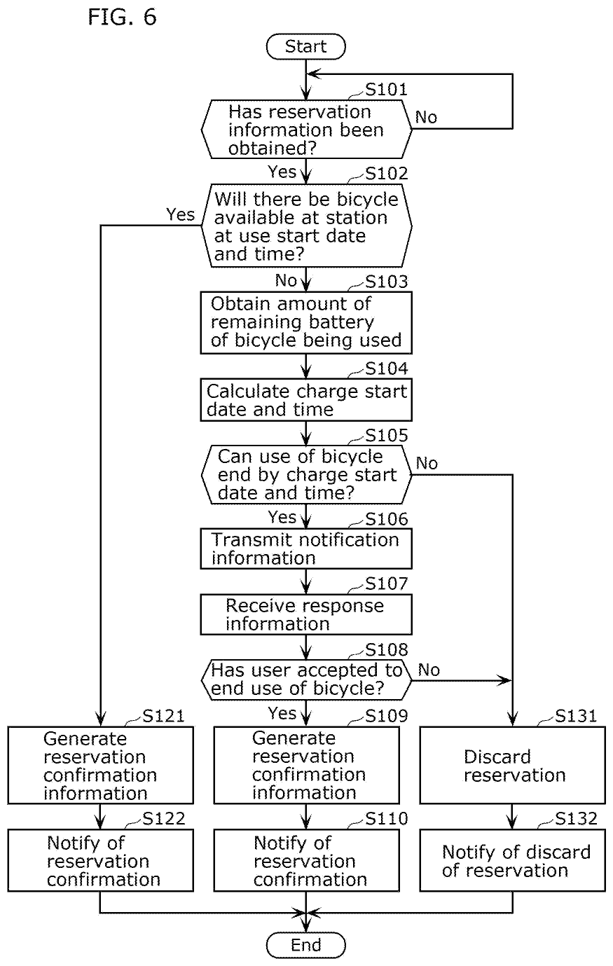

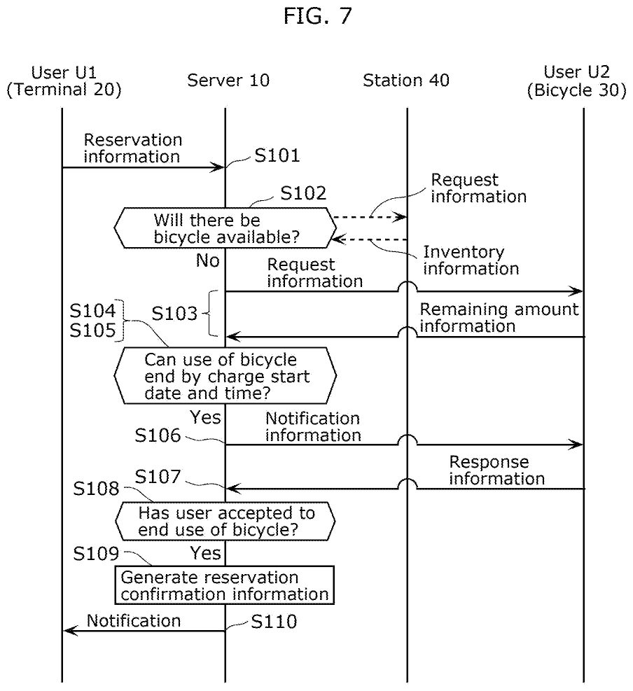

FIG. 6 is a flowchart illustrating a control method to be executed by server 10 according to the present embodiment. FIG. 7 is a sequence diagram illustrating the process of control system 1 as a whole according to the present embodiment. The process of server 10 and the process of control system 1 as a whole will be described with reference to FIG. 6 and FIG. 7. Of the processes illustrated in FIG. 7, the processes that are the same as the processes of server 10 illustrated in FIG. 6 are given the same reference characters, and detailed descriptions thereof may be omitted.

At step S101, obtainer 11 determines whether obtainer 11 has obtained reservation information from terminal 20 of user U1. If obtainer 11 has obtained the reservation information (Yes at step S101), the process proceeds to step S102. If obtainer 11 has not received the reservation information (No at step S101), obtainer 11 executes step S101 again. In other words, obtainer 11 remains in a standby state at step S101 until obtainer 11 obtains the reservation information.

At step S102, obtainer 11 determines whether bicycle 30 that user U1 can use is available at station 40 at the use start date and time included in the reservation information obtained at step S101. For example, obtainer 11 transmits request information requesting for inventory information indicating bicycle or bicycles 30 that station 40 will have available at the use start date and time. Then, obtainer 11 obtains the inventory information that station 40 transmits in response to the received request information (see FIG. 7). Then, based on the obtained inventory information, obtainer 11 determines whether there will be bicycle 30 that user U1 can use available at station 40 at the use start date and time. If there will be bicycle 30 that user U1 can use available at station 40 at the use start date and time (Yes at step S102), the process proceeds to step S121. If there will be no bicycle 30 that user U1 can use available at station 40 at the use start date and time (No at step S102), the process proceeds to step S103.

At step S103, obtainer 11 obtains the amount of remaining battery of bicycle 30 that is currently being used. For example, obtainer 11 transmits request information to each of bicycles 30 that are currently being used to request each bicycle 30 to inform obtainer 11 of the amount of battery remaining therein. Then, obtainer 11 obtains remaining amount information that each bicycle 30 transmits in response to the received request information (see FIG. 7).

At step S104, calculator 12 calculates the charge start date and time based on the amount of remaining battery obtained at step S103 and the predetermined charging characteristic unique to that battery.

At step S105, notifier 13 determines whether the use of bicycle 30 can end by the charge start date and time calculated at step S104. For example, if the present time is past the charge start date and time calculated at step S104, notifier 13 determines that ending the use of bicycle 30 by the charge start date and time is not possible (i.e., is impossible). Meanwhile, if the position information of bicycle 30 can be obtained, with an assumption that bicycle 30 travels to station 40 from the present time, notifier 13 may calculate the charge start date and time to be calculated at step S104 by using a point in time at which bicycle 30 will start being charged upon having traveled to station 40. Then, obtainer 13 may determine that ending the use of bicycle 30 by the charge start date and time is not possible if the stated point in time is past the calculated charge start date and time. In this case, the charge start date and time may be calculated by use of the amount of remaining battery obtained by subtracting the amount of electric power to be consumed by the time bicycle 30 has traveled to station 40 from the amount of battery remaining at the present time, instead of using the amount of battery remaining at the present time. If notifier 13 has determined that ending the use of bicycle 30 by the charge start date and time is possible (Yes at step S105), the process proceeds to step S106. If notifier 13 has determined that ending the use of bicycle 30 by the charge start date and time is not possible (No at step S105), the process proceeds to step S131.

At step S106, notifier 13 transmits, to bicycle 30, notification information including the charge start date and time calculated by calculator 12 at step S104.

At step S107, processor 14 receives response information that bicycle 30 returns in response to receiving the notification information transmitted at step S106.

At step S108, processor 14 obtains information that is included in the response information received at step S107 and that indicates whether user U2 has accepted to return bicycle 30 to station 40 by the charge start date and time. Based on the obtained information, processor 14 determines whether user U2 has accepted to end the use of bicycle 30 by the charge start date and time. If processor 14 has determined that user U2 has accepted to end the use of bicycle 30 (Yes at step S108), the process proceeds to step S109. If processor 14 has determined that user U2 has not accepted to end the use of bicycle 30 (No at step S108), the process proceeds to step S131.

At step S109, processor 14 generates reservation confirmation information indicating that the reservation for bicycle 30 made by user U1 has been confirmed. The reservation confirmation information is information indicating that user U1 has made a reservation to start using bicycle 30 at the use start date and time included in the reservation information obtained at step S101.

At step S110, processor 14 notifies user U1 that the reservation that user U1 has made for bicycle 30 has been confirmed. For example, processor 14 may transmit the reservation confirmation information generated at step S109.

At step S121, processor 14 generates reservation confirmation information indicating that the reservation for bicycle 30 made by user U1 has been confirmed. This reservation confirmation information is the same as the reservation confirmation information in the description of step S109.

At step S122, processor 14 notifies user U1 that the reservation that user U1 has made for bicycle 30 has been confirmed. This notification is the same as the notification in the description of step S110.

At step S131, processor 14 discards the reservation that user U1 has made for bicycle 30. Discarding the reservation is a process of indicating that the reservation that user U1 has made as obtained at step S101 cannot be confirmed.

At step S132, processor 14 notifies user U1 that the reservation that user U1 has made for bicycle 30 has been discarded.

After user U1 has been informed at step S110 or step S122 that his or her reservation has been confirmed, processor 14 executes the providing process of providing an incentive to user U2 if processor 14 has obtained information indicating that user U2 has ended the use of bicycle 30.

Through the series of processes described above, control system 1 can further improve the operation efficiency of an electric-powered vehicle.

### Embodiment 2

According to the present embodiment, an embodiment different from Embodiment 1 of a control system that improves the operation efficiency of an electric-powered vehicle will be described. Control system 2 according to the present embodiment manages response information from a user using a bicycle and information regarding the providing of incentives by use of a distributed ledger.

The constituent elements and the processes according to the present embodiment that are the same as the constituent elements and the processes according to Embodiment 1 are given the same reference characters, and detailed descriptions thereof will be omitted.

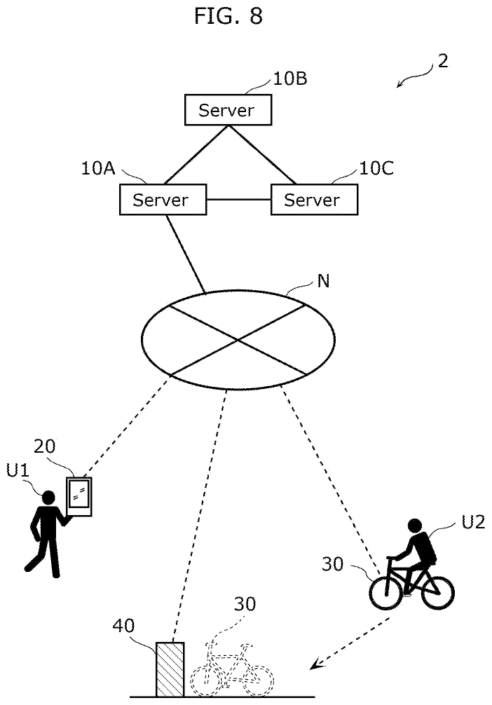

FIG. 8 is a block diagram schematically illustrating a configuration of control system 2 according to the present embodiment.

As illustrated in FIG. 8, control system 2 includes servers 10A, 10B, and 10C and station 40. Control system 2 includes servers 10A, 10B, and 10C in place of server 10 according to Embodiment 1.

Server 10A is one of a plurality of control devices that control the use of bicycle 30 by user U1 and so on. Server 10A is one of the plurality of servers 10A, 10B, and 10C each holding a distributed ledger. The distributed ledger of server 10A holds and manages response information from a user or users using a bicycle or bicycles and information regarding the providing of incentives.

Specifically, server 10A receives response information from user U2 in the form of response transaction data. Server 10A further receives provision transaction data indicating that an incentive is to be provided to user U2. Server 10A manages the received transaction data described above by use of the distributed ledger.

Servers 10B and 10C are each a device having the same function as server 10A and operate independently from server 10A. In this example, the number of the servers is not limited to three, as long as there are a plurality of servers. Server 10A and so on are connected to and are capable of communicating with each other and may be connected to each other via network N.

In this example described below, of server 10A and so on, server 10A receives various pieces of information from terminal 20 and so on, receives various pieces of transaction data, or transmits notifications to terminal 20 and so on. Alternatively, another server (server 10B or 10C) may perform these processes.

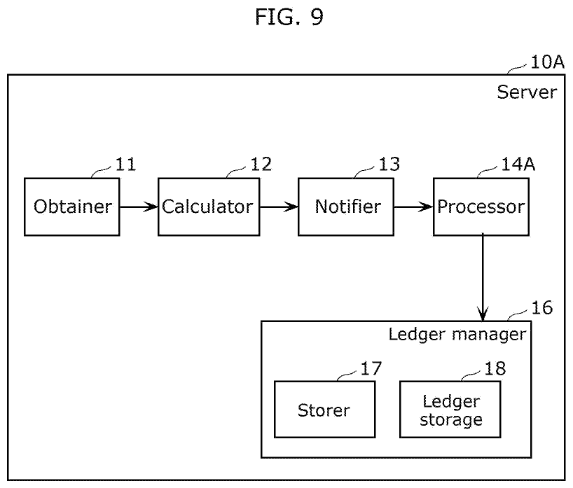

FIG. 9 is a block diagram schematically illustrating a configuration of server 10A according to the present embodiment. In this example, servers 10B and 10C each have the same configuration as server 10A.

As illustrated in FIG. 9, server 10A includes obtainer 11, calculator 12, notifier 13, processor 14A, and ledger manager 16.

Obtainer 11, calculator 12, and notifier 13 are functional units that are the same as the counterparts according to Embodiment 1, and thus descriptions thereof will be omitted.

Processor 14A is a functional unit that executes a providing process of providing an incentive to user U2. In this example, the incentive is managed by use of the distributed ledger as the providing of a token, for example. A token is value information managed by the distributed ledger. A token corresponds to money, a gift certificate, a coupon, or the like and can be exchanged between users.

Specifically, with regard to the providing process, processor 14A executes a providing process of providing user U2 with a first incentive indicated in the notification information if processor 14A has obtained information indicating that user U2 has ended the use of bicycle 30 in response to the notification information transmitted by notifier 13. In the providing process, processor 14A issues provision transaction data indicating that a first incentive is to be provided to user U2 and hands the issued provision transaction data to ledger manager 16. Moreover, processor 14A receives response transaction data that user U2 transmits in response to the notification information transmitted by notifier 13 and hands the received response transaction data to ledger manager 16. In this example, the provision transaction data is an example of transaction data that includes information regarding a first incentive.

Ledger manager 16 is a functional unit that manages the distributed ledger. Ledger manager 16 stores the transaction data provided from processor 14A into the distributed ledger. The distributed ledger holds the transaction data accumulated from the past to the present time. The transaction data described above is managed so as not to be altered, based on the characteristic that information recorded in a distributed ledger is hard to alter.

Ledger manager 16 includes storer 17 and ledger storage 18.

Storer 17 is a functional unit that stores new transaction data to be stored in the distributed ledger into ledger storage 18. Storer 17 stores new transaction data into ledger storage 18 by a scheme corresponding to the type of the distributed ledger. Moreover, storer 17 transmits and receives data to and from storer 17 of another server among server 10A and so on and causes the new transaction data to be stored into ledger storage 18 of the other server as well. For example, in a case where the distributed ledger is a blockchain, storer 17 generates a block including new transaction data and stores the generated block into ledger storage 18 upon synchronizing the generated block among servers 10A, 10B, and 10C.

Ledger storage 18 is a storage device that stores the distributed ledger. The distributed ledger stored in ledger storage 18 holds one or more items of transaction data and is managed by use of characteristics such as the hash value so that the distributed ledger is hard to alter (will be described later).

In this example, the distributed ledger is, for example, a blockchain, and this case will be described as an example. Alternatively, a distributed ledger of a different scheme (e.g., IOTA, Hashgraph, or the like) can also be employed. The distributed ledger may or may not execute a consensus algorithm (e.g., Practical Byzantine Fault Tolerance (PBFT), Proof of Work (PoK), or Proof of Stake (PoS)) at the time of storing new data. Hyperledger fabric is an example of the distributed ledger technology that does not execute a consensus algorithm.

The process of server 10A and so on and the process executed by control system 2 configured as described above will now be described.

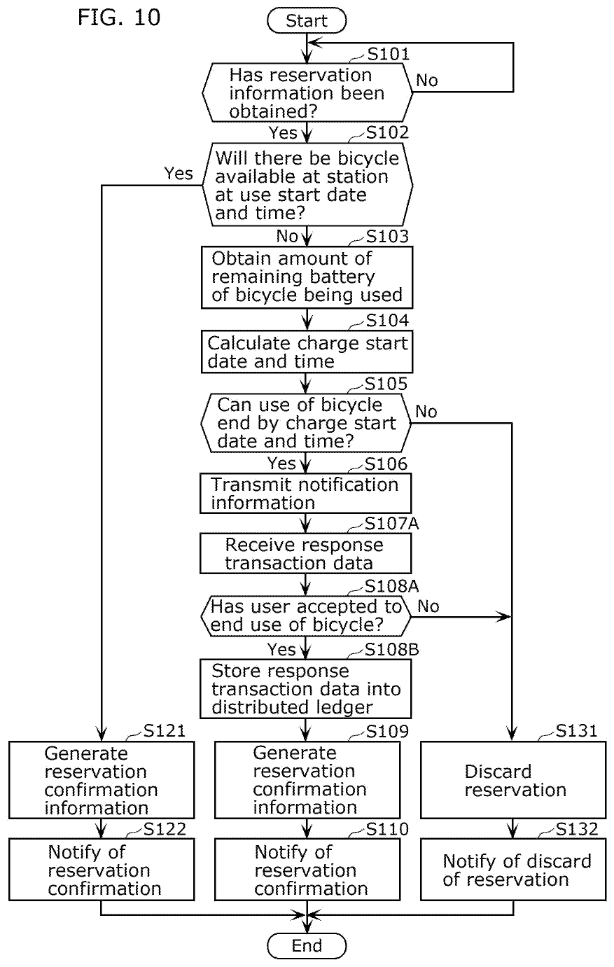

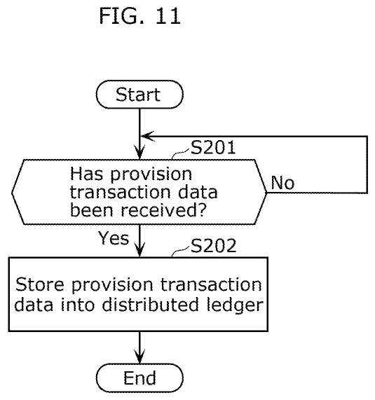

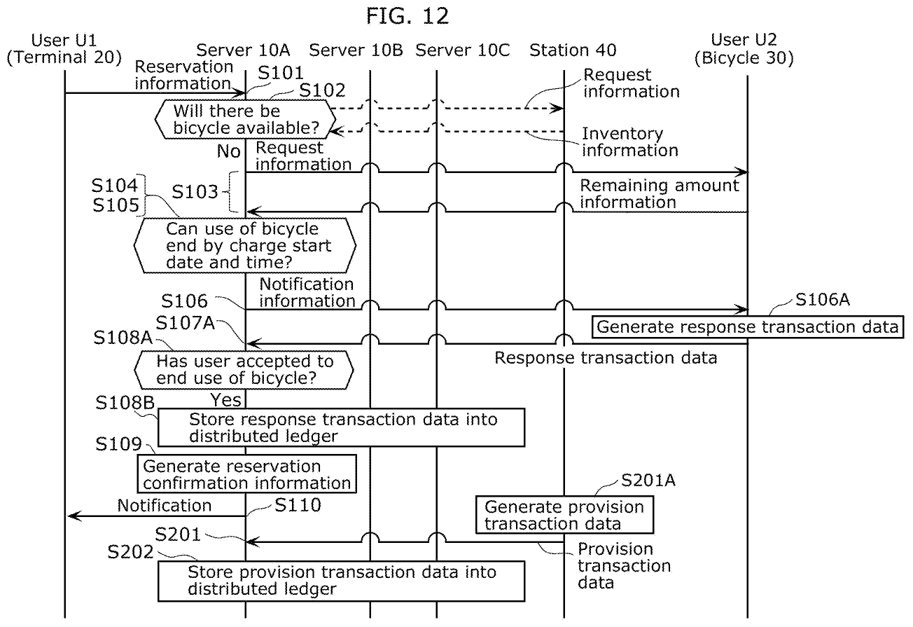

FIG. 10 and FIG. 11 are each a flowchart illustrating a control method to be executed by server 10A and so on according to the present embodiment. FIG. 12 is a sequence diagram illustrating the process of control system 2 as a whole according to the present embodiment. The process of server 10A and so on and the process of control system 2 as a whole will be described with reference to FIG. 10 to FIG. 12.

First, the processes performed from when the reservation information is obtained to when the reservation is confirmed or the reservation is discarded will be described with reference to FIG. 10 and FIG. 12.

The processes at step S101 to step S106 of FIG. 10 are the same as the corresponding processes according to Embodiment 1 (see FIG. 6).

At step S107A, processor 14A receives response transaction data that is a response to the notification information transmitted at step S106. The response transaction data is data generated and transmitted by bicycle 30 that has received the notification information that processor 14A has transmitted at step S106 (see step S106A of FIG. 12). The response transaction data is transaction data that includes information indicating whether user U2 has accepted to end the use of bicycle 30 and may be stored later into the distributed ledger.

At step S108A, processor 14A obtains information that is included in the response transaction data received at step S107A and that indicates whether user U2 has accepted to return bicycle 30 to station 40 by the charge start date and time. Based on the obtained information, processor 14A determines whether user U2 has accepted to end the use of bicycle 30 by the charge start date and time. If processor 14A has determined that user U2 has accepted to end the use of bicycle 30 (Yes at step S108A), the process proceeds to step S108B. If processor 14A has determined that user U2 does not accept to end the use of bicycle 30 (No at step S108A), the process proceeds to step S131.

At step S108B, processor 14A provides the response transaction data received at step S107A to ledger manager 16 and thus stores the response transaction data into the distributed ledger. Moreover, processor 14A transmits the response transaction data to other server 10B and so on to cause the response transaction data to be stored in the distributed ledger of each of server 10A and so on. After step S108B is completed, the process proceeds to step S109. The processes at and after step S109 are the same as the corresponding processes according to Embodiment 1.

Next, the providing process of providing an incentive will be described with reference to FIG. 11 and FIG. 12.

As illustrated in FIG. 11, at step S201, processor 14A determines whether processor 14A has received the provision transaction data. The provision transaction data is data generated and transmitted by station 40 when user U2 has moved bicycle 30 to station 40 to return bicycle 30 (see step S201A of FIG. 12). If processor 14A has received the provision transaction data (Yes at step S201), the process proceeds to step S202. If processor 14A has not received the provision transaction data (No at step S201), processor 14A executes step S201 again. In other words, processor 14A remains in a standby state at step S201 until processor 14A receives the provision transaction data.

At step S202, processor 14A provides the provision transaction data received at step S201 to ledger manager 16 and thus stores the provision transaction data into the distributed ledger. Moreover, processor 14A transmits the provision transaction data to other server 10B and so on to cause the provision transaction data to be stored in the distributed ledger of each of server 10A and so on.

Through the series of processes described above, control system 2 can further improve the operation efficiency of an electric-powered vehicle while effectively keeping the information exchanged with the users from being altered.

### (Supplementation)

The descriptions on the blockchain according to the foregoing embodiments or their variations will be supplemented.

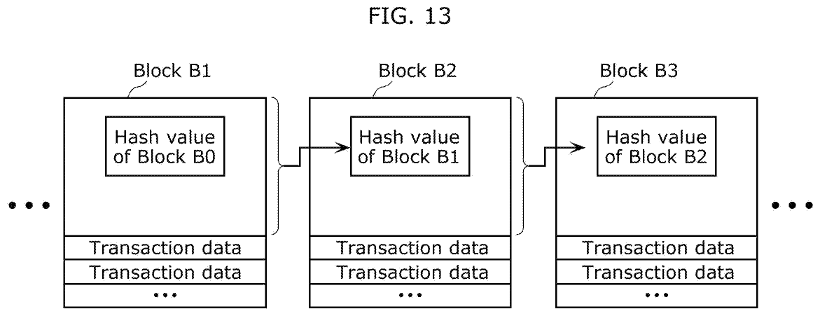

FIG. 13 is a diagram illustrating a data structure of a blockchain.

A blockchain is composed of blocks, each serving as a recording unit of the blockchain, connected in a chain-like manner. Each of the blocks includes a plurality of pieces of transaction data and the hash value of the block immediately preceding itself. Specifically, block B2 includes the hash value of block B1 preceding block B2. Then, the hash value calculated based on the plurality of pieces of transaction data included in block B2 and the hash value of block B1 is held in block B3 as the hash value of block B2. In this manner, as the content of the preceding block is included as the hash value and as the blocks are connected in a chain-like manner, any alteration of the recorded transaction data can be prevented effectively.

If past transaction data is modified, the hash value of the modified block takes a value different from the value held before the modification. Therefore, in order to make an altered block appear as if no alteration has been made, all the blocks following the altered block need to be recreated, and such an operation is very difficult in reality. The use of this property can ensure that a blockchain is hard to alter.

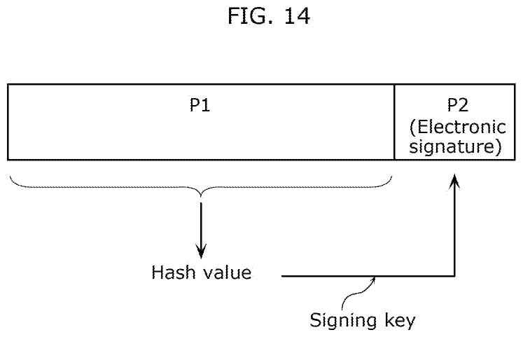

FIG. 14 is a diagram illustrating a data structure of transaction data.

The transaction data illustrated in FIG. 14 includes transaction body P1 and electronic signature P2. Transaction body P1 is data body included in the transaction data. Electronic signature P2 is generated as the hash value of transaction body P1 is signed with a signing key of the creator of the transaction data, or more specifically, as the hash value of transaction body P1 is encrypted by a private key of the creator.

Since the transaction data includes electronic signature P2, it is substantially impossible to alter the transaction data. This can keep the transaction body from being altered.

As described above, with the control method according to the foregoing embodiments, the second user is informed, via the electric-powered vehicle, of the charge start date and time at which the electric-powered vehicle should start being charged so that the electric-powered vehicle to be used by the first user at a future time will have a sufficient amount of remaining battery at the time when the electric-powered vehicle is to be used by the first user. The second user can find the charge start date and time at which the electric-powered vehicle should start being charged so that the electric-powered vehicle being used by the second user will have a sufficient amount of remaining battery when that electric-powered vehicle is to be used by the first user at a future time. If the second user who has come to know the charge start date and time ends the use of the electric-powered vehicle by the informed charge start date and time, the electric-powered vehicle can be charged after the second user has ended the use of the electric-powered vehicle and can then be used by the first user. If such a management is not performed, the electric-powered vehicle may have an insufficient amount of battery remaining when the first user hopes to start using the electric-powered vehicle, and the battery may be depleted while the first user is using the electric-powered vehicle, possibly making the electric-powered vehicle inoperable. As the second user is informed of the charge start date and time as described above, the electric-powered vehicle having a sufficient amount of remaining battery can be operated and shared efficiently among a plurality of users. Therefore, the control method according to one aspect of the present disclosure can improve the operation efficiency of an electric-powered vehicle.

Moreover, the second user is informed that the second user can be provided with an incentive if the second user ends the use of the electric-powered vehicle by the notified charge start date and time. Since the second user can be provided with an incentive if the second user ends the use of the electric-powered vehicle by the notified charge start date and time, this can motivate the second user to end the use of the electric-powered vehicle by the notified charge start date and time. As a result, this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

Moreover, the second user who has ended the use of the electric-powered vehicle by the notified charge start date and time can be provided with an incentive. In this manner, since the processes such as the transmission of the notification information as well as the process of providing the incentive can be executed as a series of processes, the efficiency of information processing improves, and the power consumption can be reduced advantageously. Therefore, the control method according to one aspect of the present disclosure can improve the operation efficiency of an electric-powered vehicle while improving the efficiency of information processing.

Moreover, if the second user is to end the use of the electric-powered vehicle by the charge start date and time in accordance with the notification information, the incentive that the second user is to be provided with is greater as the second user ends the use of the electric-powered vehicle earlier. Therefore, this can motivate the second user to end the use of the electric-powered vehicle earlier. As a result, this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

Moreover, if the second user is to end the use of the electric-powered vehicle by the charge start date and time in accordance with the notification information, the incentive that the second user is to be provided with is greater as the second user ends the use of the electric-power vehicle at a charging station closer to the charging station where the first user who is to use the electric-powered vehicle next is to start using the electric-powered vehicle. Therefore, this can motivate the second user to end the use of the electric-powered vehicle at a charging station closer to the charging station where the first user is to start using the electric-powered vehicle. As a result, this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

Moreover, if the second user is to end the use of the electric-powered vehicle by the charge start date and time in accordance with the notification information, the incentive that the second user is to be provided with is greater as the second user transmits the acceptance information earlier. Therefore, this can motivate the second user to transmit the acceptance information earlier. As a result, more pieces of acceptance information are transmitted, and this can increase the probability that the first user can use the electric-powered vehicle currently being used by the second user after the second user has ended the use of the electric-powered vehicle and the electric-powered vehicle has been charged. Therefore, the control method according to one aspect of the present disclosure can further improve the operation efficiency of an electric-powered vehicle.

Moreover, since it is practically impossible to alter the transaction data stored in the distributed ledgers, the information regarding the incentives can be managed appropriately. Therefore, the control method according to one aspect of the present disclosure can improve the operation efficiency of an electric-powered vehicle while managing the information appropriately.

Moreover, the charge start date and time can be calculated more simply and more accurately by use of the charging characteristic of the battery. Therefore, the control method according to one aspect of the present disclosure can improve the operation efficiency of an electric-powered vehicle by use of the charge start date and time that is based on a simpler and more accurate calculation.

Moreover, since it suffices that the electric-powered vehicle be charged until the electric-powered vehicle has an amount of remaining battery necessary for the first user to use the electric-powered vehicle, the time it takes to charge the electric-powered vehicle can be reduced as compared to a case where the electric-powered vehicle is charged to have a more than necessary amount of remaining battery. Therefore, the time from when the second user ends the use of the electric-powered vehicle to when the first user starts using the electric-powered vehicle can be reduced, and in turn the operation efficiency of the electric-powered vehicle can be further improved. In this manner, the control method according to one aspect of the present disclosure can improve the operation efficiency of an electric-powered vehicle.

In the foregoing embodiments, the constituent elements may each be implemented by dedicated hardware or may each be implemented through the execution of a software program suitable for the corresponding constituent element. The constituent elements may each be implemented as a program executing unit, such as a CPU or a processor, reads out a software program recorded on a recording medium, such as a hard disk or a semiconductor memory, and executes the software program. Herein, the software that implements the control method and so on of the foregoing embodiments is a program such as the one described below.

Specifically, this program causes a computer to execute a control method that includes obtaining, from a first terminal of a first user, reservation information including a use start date and time of an electric-powered vehicle that the first user hopes to use at a future time and that is being used by a second user; obtaining an amount of remaining battery of the electric-powered vehicle; calculating a charge start date and time based on the amount of remaining battery obtained, the charge start date and time being a date and time at which the electric-powered vehicle should start being charged so that an amount of remaining battery of the electric-powered vehicle becomes no less than a predetermined value at the use start date and time included in the reservation information obtained; and transmitting notification information including the charge start date and time calculated to the electric-powered vehicle.

Thus far, the control system and so on according to one or more aspects have been described based on the embodiments, but the present disclosure is not limited to these embodiments. Unless departing from the spirit of the present disclosure, an embodiment obtained by making various modifications that are conceivable by a person skilled in the art to the present embodiments or an embodiment obtained by combining the constituent elements in the different embodiments may also be included within the scope of the one or more aspects.

### INDUSTRIAL APPLICABILITY

The present disclosure can be used in a control system that manages the use of an electric-powered vehicle.

1. A control method, comprising:
obtaining, from a first terminal of a first user, reservation information including a use start date and time of an electric-powered vehicle that the first user hopes to use at a future time and that is being used by a second user;
obtaining an amount of remaining battery of the electric-powered vehicle;
calculating a charge start date and time based on the amount of remaining battery obtained, the charge start date and time being a date and time at which the electric-powered vehicle should start being charged so that an amount of remaining battery of the electric-powered vehicle becomes no less than a predetermined value at the use start date and time included in the reservation information obtained; and
transmitting notification information including the charge start date and time calculated to the electric-powered vehicle.

2. The control method according to claim 1, wherein
the notification information further includes information regarding a first incentive that is to be provided to the second user when the second user moves the electric-powered vehicle to a charging station to end use of the electric-powered vehicle by the charge start date and time calculated.

3. The control method according to claim 2, further comprising:
executing a providing process of providing the second user with the first incentive included in the notification information, in response to obtaining information indicating that the second user has ended the use of the electric-powered vehicle.

4. The control method according to claim 3, wherein
the providing process further includes a process of providing the second user with a second incentive, and
the earlier the second user ends the use of the electric-powered vehicle, the greater the amount of the second incentive is.

5. The control method according to claim 3, wherein
the reservation information includes information for identifying a starting station, the starting station being a charging station in a use start location of the electric-powered vehicle that the first user hopes to use,
the providing process further includes a process of providing the second user with a second incentive, and
the closer an ending station is to the starting station, the greater the amount of the second incentive is, the ending station being a charging station where the second user ends the use of the electric-powered vehicle.

6. The control method according to claim 3, wherein
when there are a plurality of candidate vehicles, the notification information is transmitted to each of the plurality of candidate vehicles, the plurality of candidate vehicles each being a candidate to be used as the electric-powered vehicle that the first user is to use at a future time,
one or more items of acceptance information are received, the acceptance information indicating that the second user of the candidate vehicle that received the notification information has accepted to end the use of the electric-powered vehicle, and
the providing process of providing the first incentive is executed only for the second user who transmitted the acceptance information received at an earliest time among the one or more items of acceptance information received.

7. The control method according to claim 6, further comprising:
generating transaction data including information regarding the first incentive; and
storing the transaction data generated into a plurality of distributed ledgers.

8. The control method according to claim 1, wherein
when the charge start date and time is calculated, the charge start date and time is calculated by calculating a time it takes for an amount of remaining battery of the electric-powered vehicle to reach the predetermined value from the amount of remaining battery obtained, by use of a predetermined charging characteristic unique to a battery of the electric-powered vehicle.

9. The control method according to claim 1, wherein
the reservation information includes path information indicating a path along which the first user travels by the electric-powered vehicle, and
the predetermined value is calculated as a value obtained by adding an amount of electric power required for the electric-powered vehicle to travel along the path indicated by the path information to a lower limit value of an amount of remaining battery of the electric-powered vehicle.

10. A control system, comprising:
a server; and
a charging station, wherein
the charging station includes charging equipment for charging an electric-powered vehicle, and
the server includes:
an obtainer that (a) obtains, from a first terminal of a first user, reservation information including a use start date and time of an electric-powered vehicle that the first user hopes to use at a future time and that is being used by a second user and (b) obtains an amount of remaining battery of the electric-powered vehicle;
a calculator that calculates a charge start date and time based on the amount of remaining battery obtained, the charge start date and time being a date and time at which the electric-powered vehicle should start being charged so that an amount of remaining battery of the electric-powered vehicle becomes no less than a predetermined value at the use start date and time included in the reservation information obtained; and
a notifier that transmits notification information including the charge start date and time calculated to the electric-powered vehicle.

11. A non-transitory computer-readable recording medium for use in a computer, the recording medium having a computer program recorded thereon for causing the computer to execute the control method according to claim 1.
